(19) United States
(12) Patent Application Publication
(10) Pub. No.: US 2017/0024821 A1
(43) Pub. Date: Jan. 26, 2017

(54) PREDICTIVE, INTEGRATED SOFTWARE DESIGNED TO OPTIMIZE HUMAN AND FINANCIAL CAPITAL OVER LIFE OF USER

(71) Applicant: Tectonic Advisors, LLC, Plano, TX (US)

(72) Inventor: A. Haag Sherman, Houston, TX (US)

(73) Assignee: Tectonic Advisors, LLC, Plano, TX (US)

(21) Appl. No.: 15/206,132

(22) Filed: Jul. 8, 2016

Related U.S. Application Data
(60) Provisional application No. 62/195,181, filed on Jul. 21, 2015.
(60) Provisional application No. 62/220,738, filed on Sep. 18, 2015.

(51) Int. Cl. G06Q 40/06; G06Q 40/08

(52) U.S. Cl. CPC G06Q 40/06; G06Q 40/08

(57) ABSTRACT

A method, system, and machine-readable medium with instructions for performing the method configured to meet a financial goal. The method includes accepting user information, estimating a target volatility of the user, preparing an investment plan based on the user information and the target volatility, and providing the investment plan to the user. The target volatility may be determined using a revealed risk tolerance based on behavioral analytics. The method may also include preparing and presenting an insurance plan to protect human capital of the user and pooling buying power of the user with additional parties to realize discounts on goods and services. The system includes a computer for executing instructions to perform the method and communicating with the user.

This is a conversion of, and claims a benefit of priority under 35 U.S.C. §119 from U.S. Provisional Application No. 62/195,181, filed Jul. 21, 2015, and 62/220,735, filed Sep. 18, 2015, which are hereby fully incorporated by reference in their entirety.

### 1. FIELD OF THE DISCLOSURE

The present disclosure relates to systems and methods for financial management, and more particularly relates to systems and methods for creating and estimating value as well as managing risk in financial portfolios.

### 2. DESCRIPTION OF THE RELATED ART

With the decline of defined benefit plans, investors are increasingly required plan and save for their own retirement. However, many investors have not saved an adequate amount to meet their goals without reductions in spending. Additionally, most investors have trouble assessing how to adequately manage risks to their human capital at minimal cost and reducing spending on every day consumables, which enhances the ability to save. Finally, most investors do not have a clear assessment of their current or future financial health, do not understand the true worth of the net present value of their earning power, and are uncertain about how to invest order to shift from a state of receiving income from human capital to receiving income from financial capital while minimizing risk of not meeting their financial goals. Investors in any or all of these three situations above will benefit from methods for reducing spending without a concomitant reduction in standard of living, managing risks to their human capital at minimal cost, better investing, and clear transparency into their current and future financial health.

Very few individual investors or financial advisors incorporate analysis of insurance needs. However, if present value of future earning power is one's most valuable asset, this is a major oversight, as there is huge risk if that earning power is damaged which must be insured against. Unfortunately, that present value of individual earning power may shift over time, particularly as the investor accumulates sufficient financial assets to mitigate the need of insuring financial capital. These shifts change insurance needs and further complicate insurance purchasing decisions.

Few investors have an accurate picture of their present or future financial health. Many only rarely pause to take stock of their assets and liabilities, and almost none consider the value of their earning power, which is usually the most valuable asset for anyone not nearing retirement. Furthermore, most investors do not have the time or skills to build advanced financial projections for their investments and lives, and most investors find that having a professional financial advisor do this is often too expensive and/or time-consuming.

Investors currently face a choice between self-directed investing, which can suffer from lack of discipline, lack of financial knowledge, and lack of diversification (resulting in subpar returns) or between outsourcing the job to a financial advisor, which can suffer from high fees, failure to outperform broad indices, and inadequate guidance on asset allocation (again resulting in subpar returns). Additionally, self-directed investors or investors with financial advisors who do not spend adequate time on individual analysis end up with non-customized investment plans that do not meet their objectives of returns and/or volatility.

Finally, communication to investors regarding their portfolios and financial health, along with advice on how to optimize investing, risk management, and spending, is often woefully inadequate. Market analysis (a critical duty of financial advisors) is too often omitted or provided too infrequently for volatile markets.

There is a need for integration of all these components to provide synergy (e.g. the effect on future financial health of saving on utilities, cell phone services, insurance, and/or other expenditures) with the resulting savings deposited into an investment portfolio.

Further, there is a need for increasing the probability of investors to have sufficient income in retirement or another preselected time or event to maintain their lifestyle (a common metric is a replacement ratio of 70% of preretirement income). There is a need for providing feedback to investors as to how their decisions or potential decisions impact the probability of the investor meeting a specified financial goal. There is also a need for determining insurance needs as part of risk management strategy for investors to mitigate the damage of unexpected, catastrophic events in the lives of individuals, again minimizing the probability of an investor being left with insufficient income when they can no longer work. As such, consolidated and transparent management of financial and human capital is disclosed.

### SUMMARY OF THE DISCLOSURE

In aspects, the present disclosure is related to systems and methods for financial management. Specifically, the present disclosure is related to providing systems and methods for estimating value and managing risk in financial portfolios

One embodiment of the present disclosure includes a method for realizing a financial goal, the method comprising: accepting user information related to the financial goal into a computer memory; estimating a target volatility based on the user information; preparing an investment plan to meet the financial goal based on the user information and the estimated target volatility; and providing the investment plan to the user. In the method, estimating the target volatility may include: determining a revealed risk tolerance of the user based on the user information; and calculating the target volatility based on the revealed risk tolerance. If the user information related to the financial goal includes a missing data element, then the method may include the steps of: constructing a profile of the user based on the user information; and supplying the missing data element using actuarial data based on the profile. The method may also include: receiving an acceptance of the investment plan from the user; and providing the user with documents for implementing the investment plan. The method may also include: monitoring performance of the investment plan; and providing updates on the performance of the investment plan to the user. The method may also include: receiving instructions from the user to modify the investment plan; and modifying the investment plan based on the user instructions. The user information related to the financial goals may include responses to one or more behavioral analytics questions pertaining to investment risk, and wherein the revealed risk tolerance is estimated based, at least in part, on the responses to the one or more behavioral analytics questions pertaining to investment risk. The step of preparing the investment plan may include selecting an investment portfolio from a plurality of portfolios based at least in part on the target volatility of the user. Further, each of the plurality of portfolios may have an associated estimated volatility, and the associated volatility of the selected investment portfolio is the closest to the target volatility of the user. The associated volatility of the selected investment portfolio may be lower than the target volatility of the user. The step of preparing the investment plan may include: selecting an investment portfolio from a plurality of portfolios, wherein each of the plurality of portfolios has an estimated probability of meeting the financial goal and the selected investment portfolio has the highest probability of meeting the financial goal of the plurality of portfolios. The preparation of the investment plan may further include: estimating the probabilities of meeting the financial goal for each of the plurality of portfolios and/or applying a tax-deferred savings option while estimating the probabilities of meeting the financial goal for each of the plurality of portfolios. The method may also include: estimating a value of human capital for the user; and providing an insurance plan to cover the estimated value of human capital. The value of human capital may be a net present value of an estimate of future earnings of the user. The insurance plan may include at least one of: life insurance, health insurance, and disability insurance. The method may also include: pooling buying power of the user with buying power of at least one additional party, wherein the at least one additional party is selected based on at least one common characteristic between the user information and corresponding information about the at least one additional party; and negotiating prices for products or services using the pooled buying power.

Another embodiment of the present disclosure includes a non-transitory machine-readable medium product, the non-transitory machine-readable medium containing thereon instructions that, when executed, cause a computer to perform a method, the method comprising: accepting user information; estimating a revealed risk tolerance based on the user information; preparing an investment plan based on the user information and the revealed risk tolerance; and providing the investment plan to the user. The medium may include one or more of: i) a flash drive, ii) a ROM, iii) a hard disk, iv) a solid state memory device, and v) a CD-ROM.

Another embodiment according to the present disclosure includes a system, comprising: a server computer; a client computer coupled to the server computer; and a non-transitory machine-readable memory disposed on the server computer and with instructions stored thereon that, when executed by the server computer, perform a method, the method comprising: accepting user information; estimating a revealed risk tolerance based on the user information; preparing an investment plan based on the user information and the revealed risk tolerance; and providing the investment plan to the user.

Another embodiment according to the present disclosure includes a method for determining replacement income, the method comprising: accepting user information related to current income and financial reserves and a target date for income replacement into a computer memory; estimating a value of human capital for a user based on the user information; and determining an insurance plan to cover the estimated value of human capital; and providing the insurance plan to the user. The estimating of the value of human capital for the user may include estimating future earnings of the user based on the user information; and calculating a net present value for the estimate future earnings. The step of determining an insurance plan to cover the estimated value of human capital may include: selecting at least one insurance product determined to replace the calculated net present value of the estimated future earnings. The method may include prompting a user to provide user information related to the current income and financial reserves. The method may also include receiving a user acceptance of the at least one insurance product.

Another embodiment of the present disclosure includes a non-transitory machine-readable medium product, the non-transitory machine-readable medium containing thereon instructions that, when executed, cause a computer to perform a method, the method comprising: accepting user information related to current income and financial reserves and a target date for income replacement into a computer memory; estimating a value of human capital for a user based on the user information; determining an insurance plan to cover the estimated value of human capital; and providing the insurance plan to the user. The medium may include one or more of: i) a flash drive, ii) a ROM, iii) a hard disk, iv) a solid state memory device, and v) a CD-ROM.

Another embodiment according to the present disclosure includes a system, comprising: a server computer; a client computer coupled to the server computer; and a non-transitory machine-readable memory disposed on the server computer and with instructions stored thereon that, when executed by the server computer, perform a method, the method comprising: accepting user information related to current income and financial reserves and a target date for income replacement into a computer memory; estimating a value of human capital for a user based on the user information; and determining an insurance plan to cover the estimated value of human capital; and providing the insurance plan to the user.

Examples of the more important features of the disclosure have been summarized rather broadly in order that the detailed description thereof that follows may be better understood and in order that the contributions they represent to the art may be appreciated. There are, of course, additional features of the disclosure that will be described hereinafter and which will form the subject of the claims appended hereto.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 shows a diagram of an automated and consolidated financial planning and services system in accordance with at least one embodiment of the present disclosure;

FIG. 2A shows a diagram of a computer suitable for use as a client workstation or a server in the system accordance with at least one embodiment of the present disclosure;

FIG. 2B shows a block diagram of the computer of FIG. 2A in accordance with at least one embodiment of the present disclosure;

FIG. 3 shows a diagram of a client-server configuration in accordance with at least one embodiment of the present disclosure;

FIG. 4 shows a flow chart of a method of implementing automated and consolidated management of human and financial capital in accordance with at least one embodiment of the present disclosure;

FIG. 5 shows a flow chart of a method of assessing, displaying, and optimizing financial health (defined as the probability of achieving a given minimum level of retirement income); and

FIG. 6 shows a flow chart of a method of determining a suitable amount of insurance to adequately manage the risk to a user's human capital from death, disability, or other incapacitation.

### DETAILED DESCRIPTION OF THE DISCLOSURE

### Notation and Nomenclature

Certain terms are used throughout the following claims and description to refer to particular components. As one skilled in the art will appreciate, different entities may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean an optical, wireless, indirect or direct electrical connection, or other type of direct or indirect connection. Thus, if a first device couples to a second device, that connection may be through a direct electrical connection, through an indirect electrical connection via other devices and connections, through an optical connection, through The Internet, or through a wireless connection. Additionally, the term “system” refers to a collection of two or more components, and may be used to refer to an electronic device.

### DETAILED DESCRIPTION

The following discussion is directed to various embodiments of the disclosure. The embodiments disclosed should not be interpreted, or otherwise used, as limiting the scope of the disclosure, including the claims, unless otherwise specified. The discussion of limitations of any embodiment is meant only to be illustrative of that embodiment, and not intended to limit the scope of any other embodiment.

As mentioned above, many investors have not saved an adequate amount of wealth or spend too much for them to meet their retirement goals. However, the same investors are also reluctant to give up their current standard of living. As such, there is value in finding ways to live more efficiently, or in other words, to find savings for the same services that are already being consumed by the investor. These savings can be reinvested to optimize the probability of meeting retirement goals or other financial goals. It is important to demonstrate the concrete long-run effects on financial health of these small constant incremental savings in order for users of the system, which may include investors and parties performed or monitoring the financial status of an investor, to see the benefits of doing so. Thus, linking these incremental savings to a software module or program that provides transparency into financial health adds value to users.

Automated and consolidated management of human and financial capital may include many services. Financial capital relates to most aspects of quantifiable current wealth, including, but not limited to, investments, cash, insurance value, contracted income streams, income property, real estate, personal property, dividends, and capital gains. Human capital relates to earning potential or earning power for future income. Herein, human capital is the net present value (NPV) of anticipated future cash flows for an investor. Thus, human capital is the estimated earning and saving power of a person over the remainder of their working career discounted to present based on an estimated discount rate. This estimated earning power may be the basis for determining insurance and/or investment needs of the user, whether due to mortality, disability, health, or other reasons as understood by a person of ordinary skill in the art. In some embodiments, the human capital may be reduced to zero as of the user's retirement date.

The investment plan may be developed using, at least in part, quantitative methods and behavioral analytics. The results of the quantitative methods may be used to provide users with a diversified plan that includes asset allocation guidance, automated discipline, low fees, and customization to optimize (maximize) the probability of meeting financial goals. Financial goals may include, but are not limited to, one or more of: 1) a specified amount of accumulated wealth at a specified point in time, 2) a specified income stream starting at a specified point in time without depleting principal, and 3) a specified income stream starting at a specified point in time with a defined period before the principal is completely depleted given estimated future financial market performance based on historical data. Financial goals may be based on actuarial and/or user information. The results of the behavioral analytics may also be used to identify parameters of key psychological traits of users of which the users themselves might not be aware. Identification of these parameters may then be used to select appropriate portfolios that may reduce user anxiety related to financial factors, such as volatility. User anxiety may be manifested in users by failures to invest liquid assets into longer term investments, switching funds from higher risk investments with higher projected returns to lower risk investments with lower projected returns, and/or switching funds from lower risk investments with lower projected returns to higher risk investments with higher projected returns such that the estimated probability of the user meeting their financial goals is reduced. Financial goals may be based on user information, actuarial data, or combinations thereof. A financial goal may be defined as a set amount of income or replacement income ratio at a specified date. One non-limiting example of a financial goal is a set amount or income replacement ratio as of a specified retirement date.

Using input from the user and other data regarding income and projections, the system may include a program that may assess insurance needs and generate recommendations to be provided to the user. When previously obtained data from the user is used in assessing the insurance needs, the reuse of information previously collected may reduce the total time required of the user for the generation of recommendations by the system. The time saved by the user is a material benefit, and the need to enter information only once also increases the likelihood that the user will continue the process rather than drop out due to user fatigue or frustration with the financial planning process.

Additionally, since an embodiment of the system may have a plurality of users, there is the potential of buying power of the plurality of users to be pooled. For example, after a user had received a recommendation of insurance needs, they could be directed to purchase insurance at a price discounted from what they would otherwise have received. Due to the integrated nature of the system, users may also have the opportunity to peruse other discounted services, such as, but not limited to, electricity service, financial products (mortgages and other loans), mobile phone service, and other goods and services. The impact due to selecting one or more of these pooling options on saving in their retirement plan or other financial objectives may be communicated to the user via the system through the financial health module. The user may be able to view multiple options for pooling and view the impact of individual options and combinations of the options on financial goals using the system. Individual investors or users may be able to interact with the system and receive feedback based on their choices over The Internet, which, in at least one embodiment, may comprise an end to end platform. This would make it highly accessible to a wide variety of users.

The system may also include a generator of frequent and up to date reports regarding the users' portfolios. Performance results and benchmark comparisons may be semi or fully automated, and market analysis may be communicated to users with the benefits of scale. In some embodiments, this scale may be used so that a consolidation provider may offer users accountability and transparency via precise updates and/or recommendations on their portfolios, the markets as a whole, and the effect of the markets on users' portfolios. Herein, transparency means the ability of the user to view current and projected states of their financial health based on known assumptions about financial conditions, such as, but not limited to, expected growth, inflation rates, longevity, and tax rates. Communication of the user information may be conducted via electronic communications, including, but not limited to, e-mail, streaming video, texting, or secure social media.

Streamlined information gathering protocols may be employed to allow the system to tie all of these services together. Herein, streamlining of information gathering pertains to not requesting information from a user that has been previously obtained and making requests for information only when there is a proximate need for the relevant information. For example, a ZIP code of a user may be used to recommend utility savings associated with the location of the ZIP code, or the system may recommend an education savings account based on another input indicating that the user has one or more children.

As a result of automating and consolidating financial planning and services as well as reducing overhead and cutting out intermediaries, all of these services could be offered at a cost that is less than the cost of outsourcing investments to a financial advisor. Reduced or eliminated costs may include fees to brokers, financial advisors, and insurance brokers. Additionally, the savings from discounts on insurance and other services could very likely exceed the costs that are charged to the user, allowing the system to “pay for itself”.

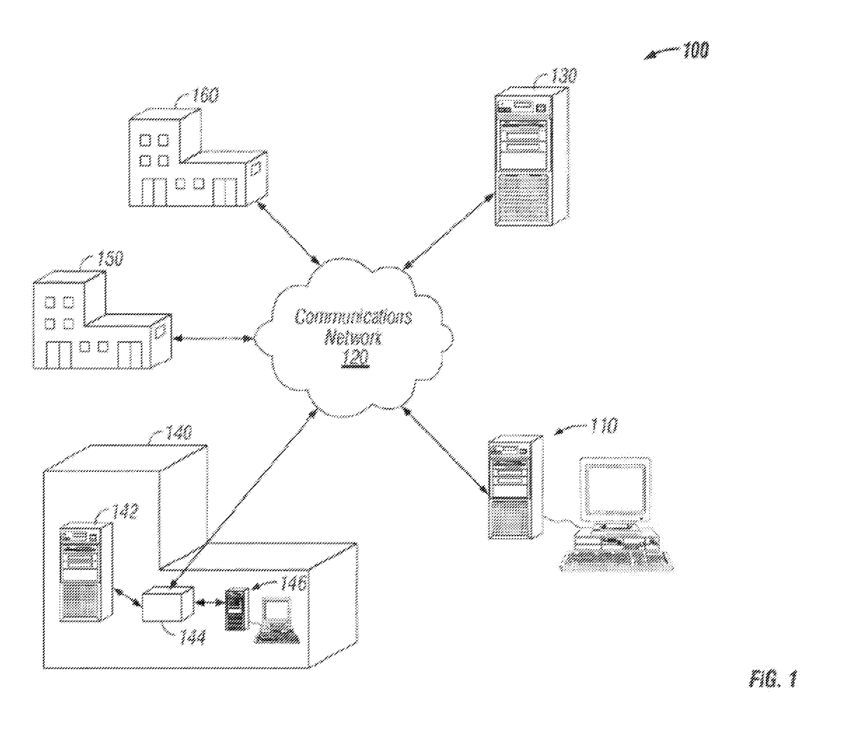

FIG. 1 shows an example system 100 for automated and consolidated financial planning and services. A client workstation 110 may include a computer, which may be operated by a user to input investor information into the system 100 and to receive at least one output from the system 100. Investor information may be input and outputs may be generated using hardware and software external to the client workstation 110, received from third party information systems, or created using the client workstation 110. The user may interact with the system 100 via the client workstation 110, and the client workstation 110 may be coupled to the server computer 130 directly or via a communications network 120. The communications network 120 may include, but is not limited to, one or more of: The Internet, an intranet, a wireless fidelity network, a cellular network, and a phone line. In at least one embodiment, the server 130 comprises a non-transitory machine-readable medium storing software that, when executed by the workstation 110, causes the workstation 110 to perform one or more of the steps described in this disclosure. In various embodiments, the non-transitory machine-readable medium includes a non-volatile memory (e.g., read only memory, flash drive, hard disk drive, solid state memory, CD-ROM, etc.). In some embodiments, some of the processing may also involve storage using a volatile memory (e.g., random access memory, etc.).

The method claimed herein may be executed on both the client workstation 110 and the server 130 to perform a method to process the user information and generate feedback for the user as one or more outputs. The server 130 may determine an investment plan for the user based on the user information as described more fully below. The server 130 may also be coupled to computer systems operated by one or more financial third parties 140, 150, 160 via the communications network 120. The financial third parties 140, 150, 160 may include, but are not limited to, one or more of: insurers, real estate brokers, investment houses, and banks. The server 130 may transmit a portion of the investment plan to the financial third parties 140, 150, 160. The transmitted portion of the investment plan may vary by financial third party 140, 150, 160 or be otherwise customized so that the portion of the investment plan is relevant to that financial third party 140, 150, 160. The server 130 may receive, from the financial third party 140, 150, 160, a quotation pertaining to investment plan. When a quotation is selected by the server 130 to be part of the investment plan to be offered to the user, the quotation may be forwarded to the workstation 110. In at least one embodiment, the quotation with the lowest bid is selected to be incorporated into the investment plan.

In the illustrative embodiment shown in FIG. 1, each financial third party 140, 150, 160 is coupled to the communications network 120 via a network interface device (e.g., network hub 144 shown as part of the facilities of the financial third party 140), which may provide connectivity between the workstation 110 and the financial third party's servers and workstations (e.g., financial third party server 142 and financial third party workstation 146). Although the client workstation 110, the server 130, and the servers and workstations 142, 146 used by the financial parties 140, 150, 160 are shown coupled to each other through a single network, multiple separate networks may be used to transfer data.

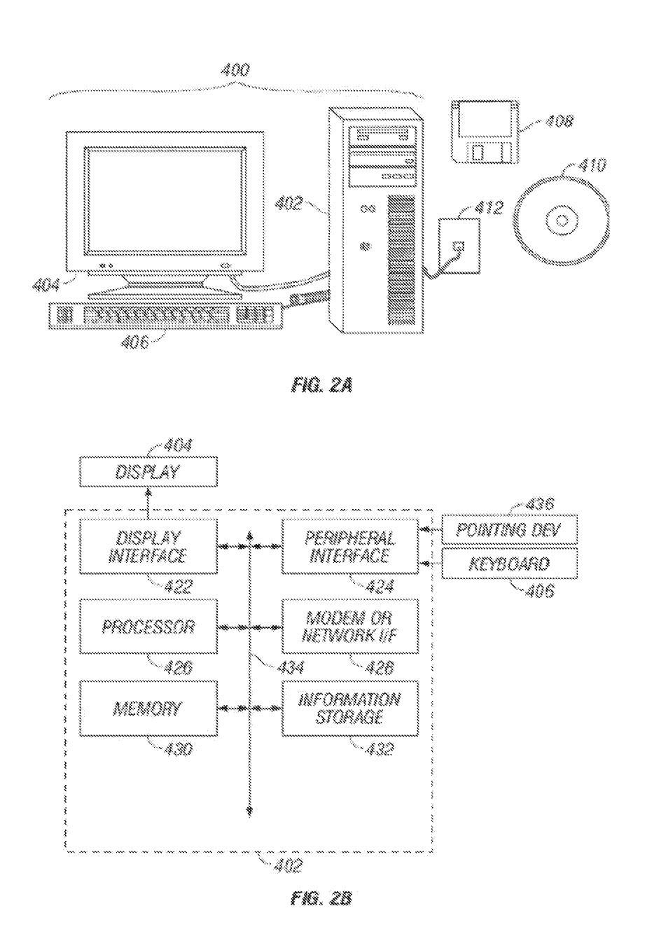

FIGS. 2A and 2B show an illustrative system configuration 400 suitable for implementing the client workstation 110, the server 130, the financial third party server 142, and the financial third party workstation 146 shown in FIG. 1. As shown, the illustrative system configuration 400 includes a chassis 402, a display 404, and an input device 406. The chassis 402 includes a processor 426, a memory 430, and a non-transitory information storage device 432. One or more information storage devices 432 may store programs and data on removable storage media, such as a floppy disk 408 or an optical disc 410. The chassis 402 also includes a network interface 428 that allows the system 400 to receive information via a local network and a wired or wireless wide area network, represented in FIG. 2A by a phone jack 412. The chassis 402 is coupled to the display 404 and the input device 406 to interact with a user. The display 404 and the input device 406 may operate together as a user interface. The input device 406 is shown as a keyboard, but other input devices such as a mouse or a keypad may also be included.

FIG. 2B shows a simplified functional block diagram of system 400. The chassis 402 may include a display interface 422, a peripheral interface 424, a processor 426, a modem or other suitable network interface 428, a memory 430, a non-transitory information storage device 432, and a bus 434. System 400 may be a bus-based computer, with a bus 434 interconnecting the other elements and carrying communications between them. The display interface 422 may take the form of a video card or other suitable display interface that accepts or receives information from the bus 434 and transforms the information into a form suitable for the display 404. Conversely, the peripheral interface 424 may accept signals from the keyboard 406 and other input devices such as a pointing device 436, and transform them into a form suitable for communication on the bus 434.

The processor 426 receives information from other system elements, including input data from the peripheral interface 424, and program instructions and other data from the memory 430, the information storage device 432, or from other systems coupled to a local area network or a wide area network via the network interface 428. The processor 426 executes the program instructions and processes the data accordingly. The program instructions may further configure the processor 426 to send data to other system elements, including user information and investment plans, which may be communicated via the display interface 422 and the display 404. The network interface 428 enables the processor 426 to communicate with other systems via a local area network or via a wide area network. In one embodiment, the memory 430 may serve as a low-latency temporary store of information for the processor 426, and the information storage device 432 may serve as a long term (but higher latency) store of information. In some embodiments, the processor 426 may receive user information from third-party memory devices or networks (such as a web portal, The Internet, and an extranet).

The processor 426, and hence the computer 400 as a whole, operates in accordance with one or more programs stored on a machine-readable medium, e.g. the information storage device 432, or received via the network interface 428. The processor 426 may copy portions of the programs into the memory 430 for faster access and/or may switch between programs or carry out additional programs in response to actuation of the input device. The additional programs may be retrieved from the storage device 432 or may be retrieved or received from other locations via the network interface 428. One or more of these programs may be executed on the system 400 causing it to perform at least some of the processing functions disclosed herein.

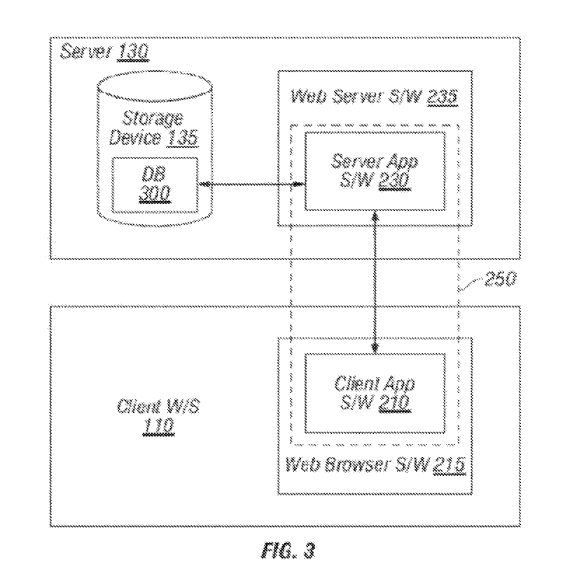

As shown in the illustrative embodiment of FIG. 3, the client application software 210 and the server application software 230 (executing on the client workstation 110 and the server 130 respectively) operate in unison as the financial processing software 250. The functionality of the financial processing software 250 may be distributed between the client and server components in a number of different ways. In at least some illustrative embodiments, most of the data manipulation and processing is concentrated in the server application software 230, resulting in a “thin” client implementation of the client application software 210, which provides the user interface. A thin client implementation means that the client is substantially a display and interface while the computer processing of core calculations and algorithms for the client/server components will be performed by on the server. Such a thin client may be implemented as a web-based client using the hypertext markup language (“HTML”), Java, or other similar browser-based software. The client application software 210 may be executed within the environment provided by web browser software 215 (e.g., Microsoft's Internet Explorer, Apple's Safari, or Mozilla's Firefox) on the client workstation 110. The client application software 210 communicates and interacts with the server application software 230, which is executed within the environment created by the web server software 235 (e.g., Apache web server software), which is in turn executed on the server 130.

By using a thin, web-based client and implementing the data processing functions on the server, application specific software does not need to be expressly installed onto the client workstation 210. A user can simply execute the web browser software 215 on the client workstation 110 and visit a service provider's website, which provides the user with access to the server application software 230 by executing the client application software 210 within the web browser software 215. The client application software 210 provides a user interface for the user to input user information to be used in creating a data file and uploading of the data file to the server 130. Preferably, the server 130 stores user information in a database 300 on a non-transitory machine-readable storage device 135. In at least some illustrative embodiments, the data file may be created at the client workstation 110 using the client application software 210. The user information uses any suitable upload data format. For example, the upload data format may include a file format such as the Adobe portable document format (“PDF”). Some of the upload data formats, such as the PDF upload data format, do not permit individual elements of the user information to be reformatted. Other upload data formats do permit manipulation and reformatting of individual elements of the user information. Those skilled in the art will recognize that many other data and file formats may be suitable for describing user information, and all such data and file formats are intended to be within the scope of the present disclosure.

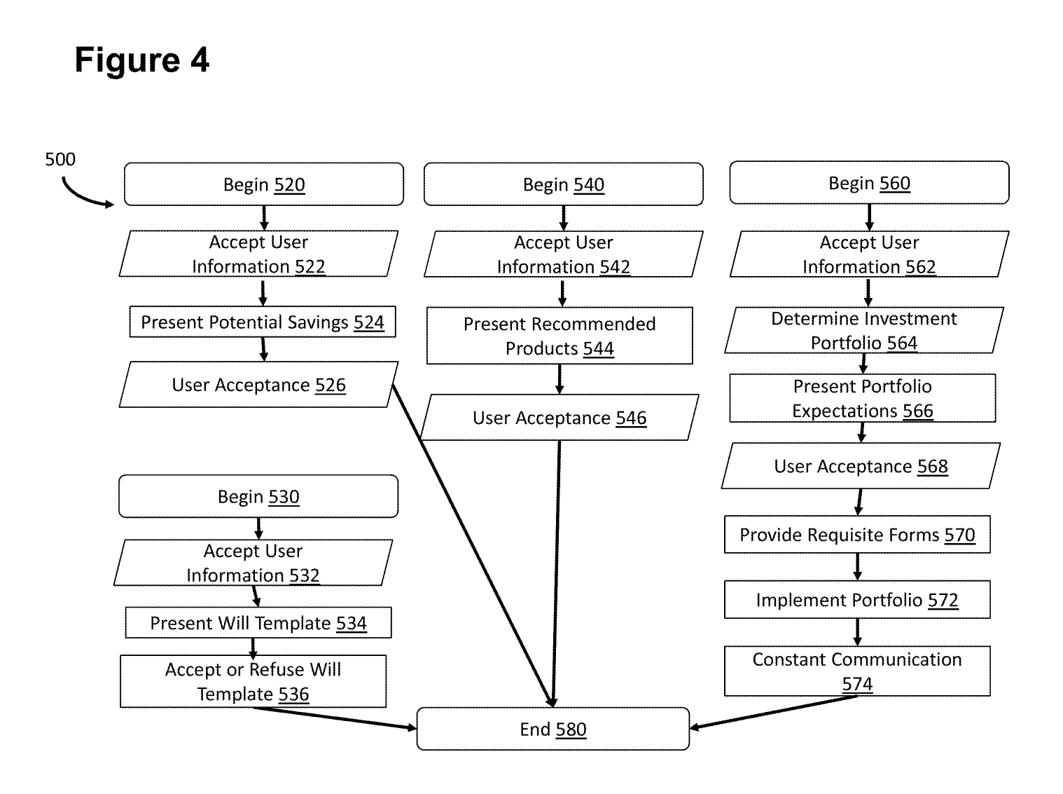

FIG. 4 shows a method 500 of implementing consolidated and transparent management of financial and human capital beginning at any of the steps 520, 530, 540, and 560 and ending at step 580. Each of the series of steps beginning with the steps 520, 530, 540, and 560 may operate in parallel, series, or combinations thereof. Each of the series of steps beginning with steps 520, 530, 540, and 560 may be repeated by the user as many times as desired to make alterations due to changing preferences or circumstances. In some embodiments, the system 100 may determine and communicate a difference between one iteration and the next iteration so that the user is informed of the impact of any alteration. The difference may include changes in the investment plan and/or changes in the probability of meeting the user's financial goal with the investment plan. In some embodiments, the method may not include all of the series 520, 530, 540, and 560 (herein series refers to a set of steps proceeding from an initiating step to the ending step). In some embodiments, the input of user information, processing, and output of an investment plan is integrated in the same system, e.g. system 100. In at least one embodiment, completion of each of the interconnected processes occurs in less than fifteen minutes, which is a substantial reduction in the amount of time for completion when compared to a non-automated non-consolidated process with the same inputs and outputs. Indeed, the majority of the less than fifteen minutes is used by the user inputting user information.

Starting with the first series 520, in step 522, user information is accepted (i.e. received) by the system 100. Series 520 may be repeated by the user as many times as desired to make alterations due to changing preferences or circumstances. If series 520 is repeated, one or more elements of information obtained during previous iterations may be reused or replaced. In some embodiments, the system 100 may determine and communicate a difference between one iteration and the next iteration so that the user is informed of the impact of any alteration. The difference may include changes in the investment plan and/or changes in the probability of meeting the user's financial goal with the investment plan. In at least one embodiment, the user uses the workstation 110 to submit user information over the network 120 to the server 130. The user may be prompted for particular user information via a program or a webpage. One or more of the answers to the questions may lead the system 100 to generate follow-up questions for additional user information. The user information may include information related to the user's spending. For example, the user information may include location of domicile, spending on utilities, spending on communications services, spending on property taxes, mortgage information, or combinations thereof. In some embodiments, mortgage information may include, but is not limited to, one or more of: user's home value, debt, current mortgage amount, current mortgage payment, current mortgage interest rate, and any future mortgage interest rates. Information necessary to secure bids must be inputted by the user to continue to step 526, but information relating to current spending may be optional. If current spending information is not available, the system 100 may use default values for a typical user. In some embodiments, a refinancing recommendation feature may require current mortgage spending information about the user to determine whether projected savings justify closing costs. The user may have the option to receive a refinance recommendation regardless of whether the projected savings meet or exceed the closing costs. In some embodiments, missing user information may be supplemented with statistical or actuarial information for a typical investor. Typical investor information may be based on demographic characteristics in common with the user as determined based on the user information available to the system 100. The user information may be prompted interactively, where a response to one question determines the selection of a follow up question to be presented by the system 100. The user information may be used to generate an initial profile for the user. The initial profile of a user may be used to associate the user with other users with similar characteristics and/or goals. Similar profiles may be used to predict additional similarities through actuarial analysis and to pool the buying power of multiple users in order to improve negotiating power and increase discounts on prices of goods and services. A non-limiting list of goods and services that may be pooled may include electricity, gas, tax consulting services, communications services, legal services, banking and mortgage products and services, automobile insurance, home insurance, cell phone services, everyday consumables, and cable services. The pooled goods and services may be obtained on a local, regional, or national basis.

In step 524, savings opportunities may be communicated to the user by the system 100. Communication may include visual display, printed reports, graphical presentation, or other communication means as understood by a person of ordinary skill in the art. Multiple savings opportunities may be stored and compared by the system 100 to inform the users of the relative impact of the savings opportunities on the user's financial goals. Optionally, quotations may have been solicited to the various financial third parties 140, 150, 160 to offer to the user via the server 130. Due to the pooled buying power of the system, such bids will likely be offered at a discount to what an individual user would be able to achieve in the market place. Once quotations (or bids) are obtained, the savings opportunities represented by the quotations may be estimated and presented to the user. The savings opportunities may be expressed to the user in terms of how they impact the financial goals and overall financial health of the user. This may be expressed as, at a specified future time, a financial value or a probability of accomplishing a financial goal. The difference between the outputs (financial value or probability), depending on whether a savings opportunity is accepted or refused, may be communicated to the user during this step. Thus, the effect on the user's financial health of accepting one or more of these bids can be seen quickly and easily, allowing the user to make an informed choice without undue cost or time commitment that it would take for a professional financial advisor to do all the series of computations for every savings option.

In step 526, the user has the option to accept one (or more) of the bids. The system 100 may provide a time interval within which the user has the option to refuse or accept one or more of the bids. The system 100 may be configured to wait until an input is received from the user or set to make a preprogramed refusal or acceptance after a set time interval. If a refusal for all of the bids is received in step 526, the method initiated at 520 terminates at 580. If an offer is accepted at 526, then the system 100 may route the user to the appropriate external provider or provide the user with the opportunity to sign up for the offer directly within the current system framework.

In another series 530, which may run in series or parallel with the series 520, facilitates generation of will documents. Series 530 may be repeated by the user as many times as desired to make alterations due to changing preferences or circumstances. If series 530 is repeated, one or more elements of information obtained during previous iterations may be reused or replaced. In some embodiments, the system 100 may determine and communicate a difference between one iteration and the next iteration so that the user is informed of the impact of any alteration. The difference may include changes in the investment plan and/or changes in the probability of meeting the user's financial goal with the investment plan. The series 530 may be independent of the series 520, or the series 530 may use information obtained during the series 520 and vice versa. In the series 530, in step 532, user information is accepted by the system 100. In at least one embodiment, the user uses the workstation 110 to submit user information over a network 120 to the server 130. The user may be prompted for selected user information via a program or webpage. Reponses from the user may determine the selection of a follow-up question to be presented by the system 100 to the user. The user information, in step 532, may include information related to the user's last will and testament. In one non-limiting example, the last will and testament component of the user information may include any combination of assets, liabilities, beneficiaries, and preferred distribution upon death. Information necessary to secure bids may be input into the system 100 in order to continue to step 534. In some embodiments, the user information may be obtained from third party systems. The user information may be used to generate an initial profile for the user. User information in any, some, or all of series 520, 530, 540, and 560 may include both overlapping and distinct parameters.

In step 534, the user may be presented with an output by the system 100. The output may be a template for a will. The output may be printed document (hard copy) or a computer file (soft copy), that may be modified (signed, reviewed, notarized, etc.).

In step 536, the user has the option to accept the will template. The system 100 may provide a time interval within which the user has the option to refuse or accept the will template. The system 100 may be configured to wait until an input is received from the user or set to make a preprogrammed refusal or acceptance after a set time interval. If a refusal of the will template is received in step 536, the method initiated at step 530 terminates at step 580. If the will template is accepted at step 536, then the system 100 may transmit a copy of the will template in a portable form (e.g. printout, downloadable file, etc.). The system may also provide a list of suitable legal service providers and/or notaries for further preparation of a formal will based on the will template.

As previously mentioned, the series 540 may run in series or parallel with the series 520 and/or 530. Series 540 may be repeated by the user as many times as desired to make alterations due to changing preferences or circumstances. If series 540 is repeated, one or more elements of information obtained during previous iterations may be reused or replaced. In some embodiments, the system 100 may determine and communicate a difference between one iteration and the next iteration so that the user is informed of the impact of any alteration. The difference may include changes in the investment plan and/or changes in the probability of meeting the user's financial goal with the investment plan. The series 540 may be independent of the series 520 and/or 530, or the series 540 may use information obtained during the series 520 and/or 530 and vice versa. In the series 540, in step 542, user information is accepted by the system 100. In at least one embodiment, the user uses the workstation 110 to submit user information over a network 120 to the server 130. The user is prompted for specific user information relevant to insurance via a program or webpage. Information supplied by the user may initiate follow-up questions to be presented to the user by the system 100. The user information related to insurance may include the user's insurance needs and spending. In one non-limiting example, the user information may include any combination of location of domicile, user age, user health, expected retirement age, income, estimated income growth, spending on life insurance, spending on auto insurance, vehicle information, and other actuarially relevant data as would be understood by a person of ordinary skill in the art. Information necessary to secure bids for insurance may be input into the system 100 in order to continue to step 546. The user information may be prompted interactively, where a response to one question determines the selection of a follow up question to be presented by the system 100. In some embodiments, the user information may be obtained from third party systems. The user information may be used to generate an initial profile for the user. The initial profile of a user may be used to associate the user with other users with similar characteristics and/or goals to pool the buying power of multiple users in order to improve negotiating power and increase discounts on prices of insurance products and services. A non-limiting list of insurance products and services that may be pooled may include automobile insurance, home owners insurance, renter's insurance, disability insurance, umbrella insurance, flood insurance, health/medical insurance, and life insurance. The pooled goods and services may be obtained on a local, regional, or national basis. In some embodiments, default values or statistically based assumptions may be substituted for some of the user information (e.g. current spending) for step 544. It should be noted that user information for series 520, 530, 540, and 560 may include overlapping and distinct parameters.

Step 542 may include a determination of the insurance needs of the user. Insurance needs may be related to, but are not limited to, insurance related to mortality, disability, unemployment, and health. In some embodiments, the insurance needs may be based on the human capital represented by the user (e.g. net present value (NPV) of the future earning power of the user), as determined based, at least in part, on the user information (e.g., dependents' needs). The NPV may be estimated based on user information and/or actuarial data. The determination of insurance needs may also include one or more of: projected income growth, age, expected retirement age, and current income. One non-limiting way to calculate NPV of future earning power is to take the sum of all future earnings adjusted to present value by dividing by an appropriate discount rate assumed by the system raised to the exponent of the number of years in the future that each cash flow event can be expected to occur.

In step 544, savings opportunities are communicated to the user by the system 100. Communication may include visual display, printed reports, graphical presentation, or other communication means as understood by a person of ordinary skill in the art. Multiple savings opportunities may be stored and compared by the system 100 to determine the relative impact of the savings opportunities on the user's financial goals. These impacts may be displayed or otherwise communicated to the user by the system 100. Optionally, bids may be solicited to various financial third parties 140, 150, 160 to offer to the user via the server 130. Due to the pooled buying power of the system 100, such bids will likely be offered at a discount to what an individual user would be able to achieve in the market place. Once quotations (or bids) are obtained, the savings opportunities represented by the quotations may be estimated and presented to the user.

The savings opportunities may be expressed to the user in terms of how they impact the financial goals and overall financial health of the user. This may be expressed as, at a specified future time, a financial value or a probability of accomplishing a financial value. The difference between the outputs (financial value or probability) depending on whether a savings opportunity is accepted or refused may be communicated to the user during this step. Thus, the effect on the user's financial health of accepting one or more of these bids can be seen quickly and easily, allowing the user to make an informed choice without undue cost or time commitment that it would take for a professional financial advisor to do all the series of computations for every savings option. In some embodiments, a comparison between the proposed savings opportunities and actual performance of the implemented savings opportunities may be prepared and presented to the user. This way the user is informed of the relationship between predicted performance and actual performance, either individually or in aggregate, of their implemented savings opportunities.

In step 546, the user has the option to accept one (or more) of the bids. The system 100 may provide a time interval within which the user has the option to refuse or accept one or more of the bids. The system 100 may be configured to wait until an input is received from the user or set to make a preprogrammed refusal or acceptance after a set time interval. If a refusal for all of the bids is received in step 546, the method initiated at step 540 terminates at step 580. If an offer is accepted at step 546, then the system 100 may route the user to the appropriate external provider or provide the user with the opportunity to sign up for the offer directly within the current system framework.

As previously mentioned, the series 560 may run in series or parallel with the series 520, 530, and/or the series 540. Series 560 may be repeated by the user as many times as desired to make alterations due to changing preferences or circumstances. If series 560 is repeated, one or more elements of information obtained during previous iterations may be reused or replaced. In some embodiments, the system 100 may determine and communicate a difference between one iteration and the next iteration so that the user is informed of the impact of any alteration. The difference may include changes in the investment plan and/or changes in the probability of meeting the user's financial goal with the investment plan. The series 560 may be independent of the series 520, series 530, and/or series 540 or the series 560 may use information obtained during either of the series 520, 530, and series 540 and vice versa. In series 560, in step 562, user information is accepted by the system 100. In at least one embodiment, the user uses the workstation 110 to submit user information over the network 120 to the server 130. The user is prompted for specific user information relevant to finance via a program or webpage. Information supplied by the user may initiate follow-up questions to be presented to the user by the system 100. The user information related to finance includes information related to the user's finances and financial goals. For example, the user information comprises any combination of the user's age, desired retirement age, current holdings, current debts, current debt interest rates, retirement contribution rate, expected outlays, other sources of income (whether now or in retirement), location of domicile, investment objectives, and personal revealed risk tolerance in at least one embodiment. In some embodiments, default values or statistically based assumptions may be substituted for some or all of the user information for step 564. The user information may be prompted interactively, where a response to one question determines the selection of a follow up question to be presented by the system 100. The user information may be used to generate an initial profile for the user. The initial profile of a user may be used to associate the user with other users with similar characteristics and/or goals to pool the buying power of multiple users in order to improve negotiating power and increase discounts on prices of financial products and services. A non-limiting list of financial products and services that may be pooled may include tax consulting services, brokerage services, investment planning services, stocks, mutual funds, bonds, financial management services, and banking services. The pooled goods and services may be obtained on a local, regional, or national basis.

Revealed risk tolerance is a user's inclination to endure a risk rather than avoid risk based on psychological analysis rather than self-reporting. Psychological studies have shown that stated preferences regarding risk of many people differ from their revealed preferences and that such revealed preferences are, in reality, what influence emotions and behavior. In at least one embodiment, revealed risk tolerance may be estimated, at least in part, by a behavioral analytics questionnaire. The behavioral analytics questionnaire may include, but is not limited to, one or more of: direct preference questions, reactions to hypothetical scenarios, and analysis of tradeoffs. The behavioral analytics questionnaire responses may be scored to estimate a true revealed risk tolerance (as opposed to the stated risk tolerance). Risk tolerance may also be estimated, at least in part, based on information (public or private) regarding the previous investment decisions made by the user. The revealed risk tolerance may be estimated using algorithms relying on inputs based on user responses in the behavioral analytics questionnaire, data on previous investment decisions made by the user, or combinations thereof. In some embodiments, the revealed risk tolerance may be calculated using weighted scores for responses to the behavioral analytics questionnaire. The true revealed risk tolerance may be expressed using a numerical value. In some embodiments, the numerical range of values for the true revealed risk tolerance may be mapped to a range of estimated volatilities for one or more of the portfolios. For example, the highest potential revealed risk tolerance value may be assigned to correspond with the highest volatility value calculated for a portfolio. Likewise, the lowest potential revealed risk tolerance value may be assigned to correspond with the lowest volatility value calculated for a portfolio. Thus, the true revealed risk tolerance may be used to determine which portfolio is optimal for the user and/or the asset allocation within the portfolio that is optimal for the user to maximize the probability of reaching the user's financial goals.

In step 564, an investment plan is prepared for the user based on the user information regarding the user's finances and financial goals. This is prepared based, at least in part, on the user information collected in step 562. In at least one embodiment, one or more algorithms based on weighted data points (including actuarial data and revealed risk tolerance) from the user information collected are executed to determine a target volatility for the user. The target volatility may then be used in the selection of an appropriate portfolio for the user. If no information has been entered, the system will select a default portfolio. The system may include a plurality of investment portfolios, each of which may include assets from one or more financial asset classes, as understood by a person of ordinary skill in the art. Each asset class may have triggers, such that, when a trigger is activated, investments in one asset class may be automatically shifted to another asset class within the portfolio and/or future investment may be redirected from intended investment in one asset class to another within the portfolio. In some embodiments, the triggers may be determined, at least in part, by volatility, momentum, and valuation of the asset class within the portfolio. In some embodiments, the user may select to cap or limit investment in a specific asset class within the portfolio. Capping of a specific asset class may be based on, but is not limited to, value and/or percentage of investments. In some embodiments, capping may be performed by selection of the user.

In at least one embodiment, portfolio selection is performed based on matching the volatility the user can be expected to withstand without anxiety to the target volatility of potential portfolios. The volatility that the user is expected to withstand without anxiety corresponds to the true revealed risk tolerance, since the true revealed risk tolerance represents the point where the user's anxiety will be sufficient to cause the user alter his financial strategy in a way that will reduce the probability of reaching the user's financial goals. Thus, the volatility that the user is expected to withstand may be based on the risk tolerance assessment of step 562. The portfolio may be chosen based on estimated expected returns, level of risk, current asset allocation, and change in asset allocation in various hypothetical scenarios.

In at least one embodiment, determining an investment plan comprises selecting a portfolio from among a plurality of portfolios based on user information, user risk tolerance, and actuarial projections. Specifically, in at least one embodiment, one of five portfolios is selected: an aggressive portfolio, a growth portfolio, a moderate portfolio, a conservative portfolio, and a capital preservation portfolio, based on the user information. The use of five portfolios is illustrative and exemplary, as any number of portfolios may be maintained by the system. In at least one other embodiment, other portfolios from outside providers are made available. Each portfolio preferably invests in exchange-traded funds, exchange-traded notes, or other low cost investment vehicles covering a variety of asset classes. The asset classes may include, but are not limited to, United States equities, developed country equities, emerging country equities, MLPs, real estate products, United States fixed income products, developed country fixed income products, emerging country fixed income products, corporate fixed income products, high yield fixed income products, MBSs, and/or commodities.

After a base allocation of an investment plan, the plan may be subsequently and continually modified by valuation adjustments; in/out triggers based on momentum, valuation, and/or volatility; and cascades for reallocation of capital from asset classes that have been exited. In at least one embodiment, the user can select an alternative portfolio than that which is recommended.

Modification of the investment plan may be based on one or more of: i) user responses when polled for additional information throughout the life of the investment plan, ii) assessment of current market information (market data, portfolio analytics, tax changes, etc.), iii) current contribution levels, iv) anticipated contribution levels, and v) savings opportunities that are predicted to modify the probability of the user meeting a financial goal.

In at least one embodiment, the allocation to an asset class can be capped or excluded. As an example, a particular objective may be to hedge another outside investment. Consider the scenario that the user information hypothetically shows over $100,000.00 in outside Treasury investments. In such a situation, the user may desire to cap the amount that gets allocated to Treasuries or exclude them from the portfolio entirely.

In at least one embodiment, the investment plan may include an analysis of tax-deferred savings options and the effect of using these tax-deferred savings options on the investment plan. Such tax-deferred options may include, but are not limited to, 401(k)s, IRAs, Roth IRAs, Keogh plans, health savings accounts, and/or education savings accounts. The system 100 may estimate the use of one or more tax-deferred options on the user's financial accounts and probability of reaching the users financial goal.

In step 566, the system 100 may communicate the determined portfolio to the user along with a cost for implementing the plan. In some embodiments, the system 100 may communicate additional portfolios to the user along with their associated costs so that the user may compare the additional portfolio and its costs with the determined portfolio and its costs. In at least one embodiment, the user is shown a graphical representation of expected investment growth over time. This graphical representation may have comparison lines drawn to represent lower portfolio totals due to fees that may have resulted from using non-automated and non-consolidated methods as well as higher portfolio totals due to reinvested discounts achieved from pooled buying power, as described in the processes initiated at steps 520, 530, and 540. The system 100 may communicate to the user one or more of: i) the probability of reaching the user's financial goal with the determined portfolio, ii) the portfolio contribution levels (absolute dollars, percentage of earnings, or other contribution measure as understood by a person of ordinary skill in the art), and iii) options for adjusting the contribution levels for the determined portfolio.

In some embodiments, a probability of reaching a financial goal for the user is calculated and presented to the user. In some embodiments, the portfolio is selected, in step 564, to maximize the probability of the user reaching his or her financial goal. The probability of reaching the financial goals may be calculated based on user information collected in step 562 as well as return and volatility characteristics of the selected portfolio. In some embodiments, additional user information collected in steps 522, 532, and 542 may also be used. The user may view how variations of user information collected in steps 522, 532, 542, and 562 and the acceptance of bids/offers presented in steps 524, 534, 544, and 566 will change the probability of reaching the financial goal. The user has the option to select a portfolio that does or does not maximize the probability of reaching the financial goal. In some embodiments, the system may alert the user if their currently selected portfolio or asset class allocation is not maximizing their probability of reaching the user's financial goal. This can all be done in an automated and integrated fashion, opening accessibility of this service to those who do not have the time and/or money to hire a professional financial advisor to do multiple customized financial analyses.

As discussed above, a financial goal may be a set amount of retirement income or a retirement income replacement ratio. Retirement income can be calculated by taking the current assets, adding in expected contributions over time, increasing the sum annually by the expected return of the portfolio, adding other sources of income or assets at or during retirement, and then using an actuarially assumed withdrawal rate. Retirement income replacement ratio can be calculated by dividing retirement income by income at the date of retirement. Probability of reaching either goal can be calculated by determining what annual growth rate would meet the financial goal, how much above or below the expected return rate of the portfolio that is, and, based on statistical methods and a normal distribution (as understood by those skilled in the art of statistics), what the probability is of the time series of the annual income stream achieving at least that level of returns. This probability can be expressed numerically, textually, graphically, or otherwise and may be in precise estimates or probability ranges.

In step 568, the user has the option to accept one (or more) of the offers. The system 100 may provide a time interval within which the user has the option to refuse or accept one or more of the offers. The system 100 may be configured to wait until an input is received from the user or set to make a preprogrammed refusal or acceptance after a set time interval. If the offer is not accepted or refused (depending on rules for acceptance/refusal) at step 568, the method initiated at step 560 terminates at step 580. If the offer is accepted at step 568, then the system 100 may provide the user with the applicable forms to implement the plan at step 570. The applicable forms may be delivered by the server 130 over the network 120 to the user at workstation 110. The applicable forms may include:

Customer Account Form

Customer Transfer Form (from Current Customer's Brokerage Account, if Applicable) Investment Policy (which Codifies the Asset Allocation of the User's Investments)

The user preferably reviews these forms, electronically signs the forms, and submits the forms. A new account is created by the server 130 and is funded by assets moved from a financial third party 140, 150, 160 brokerage account, a check, or a wire transfer. To the extent that the user has accepted quotations from financial third parties, the financial third parties are sent relevant user information for servicing. In at least one embodiment, a financial third party contacts the user via the system 100 to complete the process.

In step 572, the portfolio investments are implemented. In at least one embodiment, the investment plan is commonly managed with other investment plans of other users associated with the selected portfolio. This permits cost savings in the form of reduced transaction fees, which can be passed to the user, while still rebalancing with sufficient frequency. Once received, the assets may be held in cash, and the assets may be invested and liquidated together, e.g. on the first of the month. As such, costs can be driven further down via block trades and allocation. Preferably, implementing the investment plan comprises rebalancing the portfolio if the allocation for an asset class deviates too far from the prescribed weight for that asset class. Each user's portfolio is professionally managed based on the customized plan offered to the user. As such, the user is provided with a diversified plan with proper asset allocation guidance, automated discipline, low fees, and customization to optimize the probability of meeting investment objectives (including minimizing user anxiety resulting from volatility).

In step 574, the user is updated regularly by the system 100. Optionally, the system may continuously monitor the performance of the portfolio or portfolios in the investment plan. An automated communication apparatus may provide alert and status messages to a user. For example, the user may access information on the user's portfolio via the Internet in real time. In at least one embodiment, users may receive periodic texts, emails, or other communications, potentially including streaming video updates. The system 100 may also notify the administrators of substantial changes that require a response on behalf of the administrators. In some embodiments, the system 100 may accept alert or notification threshold values from the user and/or the administrator, and the system 100 may then generate alerts or notifications based on changes to the investments or investment plan that exceed one of the thresholds. The system 100 may communicate a message prepared to brief the user on the current market conditions and reviewing performance of the portfolio in which the user has a stake. In some embodiments, the system 100 may communicate new system services and investment options to the user, such as the strength of the financial third party firms providing the user with insurance, loans, housing market, etc. The user may also receive an annual portfolio overview along with questions designed to ensure that the investment objectives and other user information has not changed. If user information has changed, the user's plan can be adjusted accordingly. For example, insurance policies will be adjusted to reflect changes in the user's life such as marriage and the addition of dependents.

If step 522, 532, 542, or 562 is skipped (perhaps because the user is disinclined to fill out forms at that moment), savings and projected investment portfolio growth could still be presented. In one embodiment, this may consist of presenting data for a statistically average user, such as average savings on life insurance. In another embodiment, the data could be a mix of user data and assumptions derived from statistically average user or from actuarial tables. For example, a user who had not completed the risk tolerance questionnaire may be shown the results of the portfolio most actuarially appropriate for their age, income, etc.

At step 580, the user can either stop the method 500 or initiate one of the other processes by moving to any of steps 520, 530, 540, and 560.

Since the series may share data, the effect of reinvesting savings from the processes initiated at 520 and/or 540 can be shown in 566. Likewise, if ZIP code is determined in 562, it can be used to more appropriately estimate savings from utilizing pooled buying power for purchasing (e.g. to purchase utility services, goods, etc.) in step 524. Further, options selected by the user and user information submitted in each of the series 520, 530, 540, 560 may be used to calculate a probability of reaching the user's financial goals, allowing the user to be presented with the individual impact of each change to their investment plan or user information. Thus, users are provided with individualized service, and the myriad processes are automated and consolidated. As such, the user receives better investment services and communication than typically afforded to clients with financial advisors, all at a lower cost.

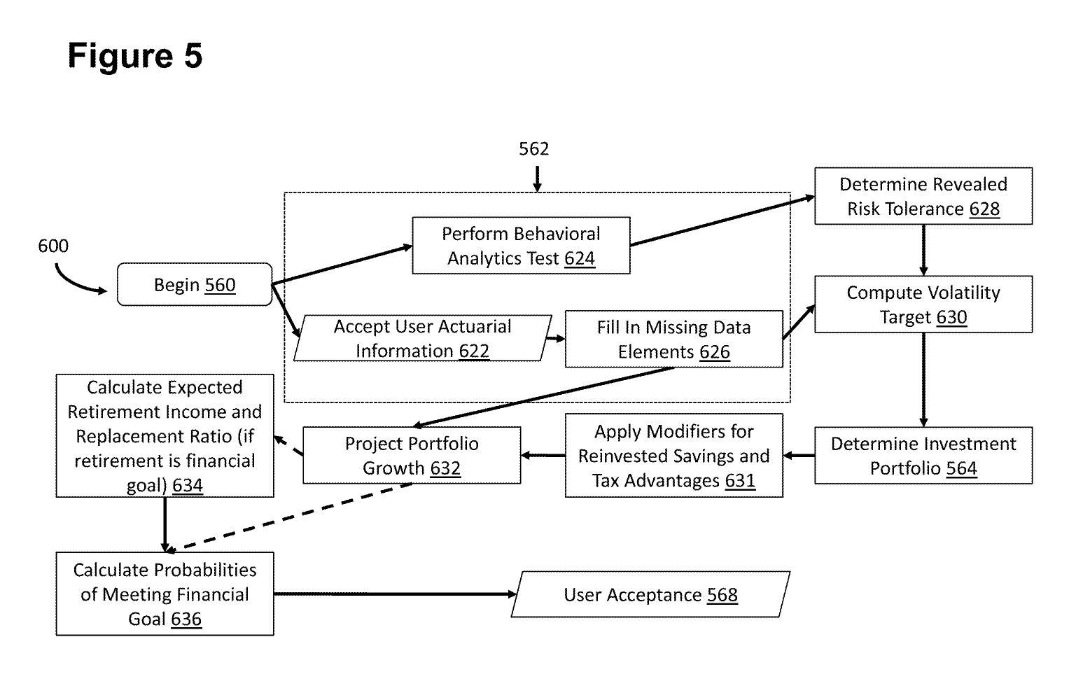

FIG. 5 shows a method 600 for assessing a user's financial health. The method 600 is a more detailed view of the method 560. Likewise, steps 622, 624, and 626 are a more detailed view of step 562. In step 622, user actuarial information is accepted by the system 100. In at least one embodiment, the user information is received from the workstation 110 due to user submission of information over the network 120 to the server 130. The system 100 may prompt the user for particular user information via a program or webpage, and particular answers to certain questions may lead to follow-up questions. The user information may include information related to the user's finances and financial goals. In one non-limiting example, the user information may include any combination of the user's age, desired retirement age, current holdings, current debts, current debt interest rates, retirement contribution rate, expected outlays, location of domicile, investment objectives, and personal revealed risk tolerance. In some embodiments, some or all of the user information related to the user's finances and financial goals and other information from steps 522, 532, and 542 may be substituted for by statistical averages and/or actuarial assumptions, as shown in step 626. The statistical averages, here and throughout, may be tailored based on known user information, such as demographics, location, gender, ethnicity, income level, etc. This known user information may be combined into a profile which is then matched to existing data to obtain the statistical averages.

In step 624, revealed risk tolerance is determined by a behavioral analytics questionnaire. Psychological studies have shown that many people's stated preferences differ from their revealed preferences and that such revealed preferences are what influence emotions and behavior. The behavioral analytics questionnaire may comprise direct preference questions, reactions to hypothetical scenarios, and/or analysis of tradeoffs.

In step 628, the behavioral analytics questionnaire responses are evaluated. The behavioral analytics questionnaire responses may be scored to estimate a true revealed risk tolerance (as opposed to the stated risk tolerance) of the user. The response scoring may be weighted or unweighted. The response scoring may then be expressed as a numerical or other value representing the true revealed risk tolerance of the user.

In step 630, proprietary algorithms are used to estimate a volatility target for the user. The volatility target may represent the maximum volatility that the user is expected to withstand before altering their investment strategy in a way that lowers the probability of the user achieving his financial goals. A range of possible true revealed risk tolerance values may be mapped to a range of volatilities for the portfolios. In some embodiments, the target volatility may be a function of the true revealed risk tolerance and other user information, including, one or more of: i) proximity to retirement age or another financial target date, ii) current income, iii) current assets, iv) and job security.

In step 564, the portfolio with the closest volatility to the computed target volatility is selected. The portfolio volatility may be actuarially calculated using techniques known to those of ordinary skill in the art.

In step 631, modifiers may be added to the portfolio. These modifiers may take two forms. The first form is modifiers for the investment benefits of tax-deferred savings options, which may be evaluated. The second form is the reinvestment of savings resulting from pooled buying power enabled by other parts of the method 500 (FIG. 4). Either or both forms of modifiers may be applied to the value of the portfolio as a whole or to a portion of the portfolio.

In step 632, portfolio growth is projected. For a set time period (e.g. 1 year), the portfolio is grown at the expected growth rate, and assumed retirement contributions are added to the portfolio total. This growth is then extended up to specific target age or number of years. In some embodiments, the target age may be an expected or assumed retirement age. Optionally, growth of one or more additional portfolios may be projected.

In step 634, projected retirement income is calculated. Retirement income can be calculated by taking the current assets, adding in expected contributions over time, increasing the sum annually by the expected return of the portfolio, adding other sources of income or assets at or during retirement, and then using an actuarially assumed withdrawal rate. Retirement income replacement ratio can be calculated by dividing retirement income by income at the date of retirement. It is also contemplated that a target income at a point in time may be calculated in the same manner, such that the user is not limited to planning for retirement. The replacement income may be calculated for non-retirement planning such as changes of careers, work load, or as compensation for changes in income.

In step 636, probability of reaching the retirement goal is calculated. Probability of reaching either goal can be calculated by determining what annual growth rate would meet the financial goal, how much above or below the expected return rate of the portfolio that is, and, based on statistical methods and a normal distribution (as understood by those skilled in the art of statistics), what the probability is of the time series of the annual income stream achieving at least that level of returns. This probability can be expressed numerically, textually, graphically, or otherwise and may be in precise estimates or probability ranges. In some possible embodiments, probabilities for alternative portfolios may be calculated and displayed as well.

After step 636, the user may proceed to step 568 (FIG. 4), at which point series 560 continues as shown.

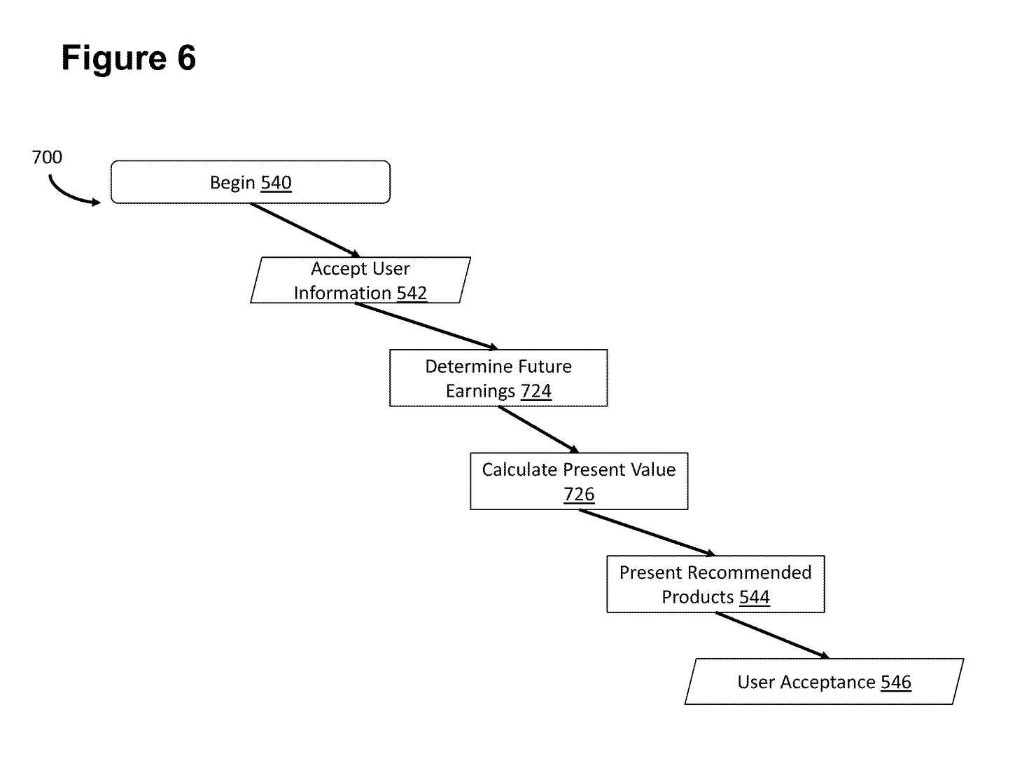

FIG. 6 shows a method 700 for determining an appropriate amount of income replacement insurance (such as life insurance or accidental death & disability insurance) required by a user to provide a lump sum or stream of income at a given point in time. The method 600 is a more detailed view of the method 540. In step 542, user information to replacement income is accepted by the system 100. In at least one embodiment, the workstation 110 communicates user information over the network 120 to the server 130 after the input by the user. The user is prompted for particular user information via a program or webpage, and particular answers to certain questions preferably lead to follow-up questions. The user information comprises information related to the user's life insurance needs. For example, the user information related to income replacement may include, but is not limited to, any combination of location of domicile, user age, user health, expected retirement age, current income, estimated income growth, current financial reserves, expected financial outlays, and expected accounts receivable.

In step 724, expected future earnings of the user are estimated. For each time period (e.g. 1 year), income is grown at the expected income growth rate and tabulated in a time series.

In step 726, NPV for the expected future earnings is calculated. As previously discussed, one non-limiting way to calculate NPV of future earning power is to take the sum of all future earnings adjusted to present value by dividing by an appropriate discount rate assumed by the system raised to the power of the number of years in the future that each cash flow event can be expected to occur.

The system may select one or more insurance products that are calculated to meet the needs of the user.

In step 544, the user is presented one or more life insurance products that cover at least their future earning power. From here, the user may proceed to step 546 (FIG. 4), at which point series 540 continues as shown.

Other conditions and combinations of conditions will become apparent to those skilled in the art, including the combination of the conditions described above, and all such conditions and combinations are within the scope of the present disclosure. The above disclosure is meant to be illustrative of the principles and various embodiment of the present disclosure. Numerous variations and modifications will become apparent to those skilled in the art once the above disclosure is fully appreciated. Also, the order of the actions shown in FIG. 4 can be varied from order shown, and two or more of the actions may be performed concurrently. It is intended that the following claims be interpreted to embrace all variations and modifications.

While the disclosure has been described with reference to exemplary embodiments, it will be understood that various changes may be made and equivalents may be substituted for elements thereof without departing from the scope of the disclosure. In addition, many modifications will be appreciated to adapt a particular instrument, situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A method for realizing a financial goal, the method comprising:
accepting user information related to the financial goal;
estimating a target volatility based on the user information;
preparing an investment plan to meet the financial goal based on the user information and the estimated target volatility; and
providing the investment plan to the user.

2. The method of claim 1, wherein estimating the target volatility comprises:
determining a revealed risk tolerance of the user based on the user information; and
calculating the target volatility based on the revealed risk tolerance.

3. The method of claim 1, wherein the user information includes a missing data element, and further comprising:
constructing a profile of the user based on the user information; and
supplying the missing data element using actuarial data based on the profile.

4. The method of claim 1, further comprising:
receiving an acceptance of the investment plan from the user; and
providing the user with documents for implementing the investment plan.

5. The method of claim 1, further comprising:
monitoring performance of the investment plan; and
providing updates on the performance of the investment plan to the user.

6. The method of claim 1, wherein the user information related to the financial goal comprises responses to one or more behavioral analytics questions pertaining to investment risk, and wherein the revealed risk tolerance is estimated based, at least in part, on the responses to the one or more behavioral analytics questions pertaining to investment risk.

7. The method of claim 1, wherein preparing the investment plan comprises:
selecting an investment portfolio from a plurality of portfolios based at least in part on the target volatility of the user.

8. The method of claim 7, wherein each of the plurality of portfolios has an associated estimated volatility and the associated volatility of the selected investment portfolio is the closest to the target volatility of the user.

9. The method of claim 8, wherein the associated volatility of the selected investment portfolio is lower than the target volatility of the user.

10. The method of claim 1, wherein preparing the investment plan comprises:
selecting an investment portfolio from a plurality of portfolios, wherein each of the plurality of portfolios has an estimated probability of meeting the financial goal and the selected investment portfolio has the highest probability of meeting the financial goal of the plurality of portfolios.

11. The method of claim 10, wherein preparing the investment plan further comprises:
estimating the probabilities of meeting the financial goal for each of the plurality of portfolios.

12. The method of claim 11, wherein preparing the investment plan further comprises:
applying a tax-deferred savings option while estimating the probabilities of meeting the financial goal for each of the plurality of portfolios.

13. The method of claim 10, further comprising:
receiving instructions from the user to modify the investment plan;
estimating a probability of meeting the financial goal if the investment plan is modified; and
communicating a difference between the modified and unmodified investment plan to the user.

14. The method of claim 1, wherein the financial goal is an actuarial target based on the user information.

15. The method of claim 14, wherein the actuarial target is based on human capital being zero as of a retirement date.

16. The method of claim 1, further comprising:
estimating a value of human capital for the user; and
providing an insurance plan to cover the estimated value of human capital.

17. The method of claim 16, wherein the value of human capital is a net present value of an estimate of future earnings of the user.

18. The method of claim 16, wherein the insurance plan comprises at least one of: life insurance, health insurance, and disability insurance.

19. The method of claim 1, further comprising:
pooling buying power of the user with buying power of at least one additional party, wherein the at least one additional party is selected based on at least one common characteristic between the user information and corresponding information about the at least one additional party; and
negotiating prices for products or services using the pooled buying power.

20. The method of claim 1, further comprising:
generating a last will and testament based on the investment plan.

21. A non-transitory machine-readable medium product, the non-transitory machine-readable medium containing thereon instructions that, when executed, cause a computer to perform a method, the method comprising:
accepting user information;
estimating a revealed risk tolerance based on the user information;
preparing an investment plan based on the user information and the revealed risk tolerance; and
providing the investment plan to the user.

22. The non-transitory machine-readable medium product of claim 21, wherein the medium comprises one or more of: i) a flash drive, ii) a ROM, iii) a hard disk, iv) a solid state memory device, and v) a CD-ROM.

23. A system, comprising:
a server computer;
a client computer coupled to the server computer; and
a non-transitory machine-readable memory disposed on the server computer and with instructions stored thereon that, when executed by the server computer, perform a method, the method comprising:
accepting user information;
estimating a revealed risk tolerance based on the user information;
preparing an investment plan based on the user information and the revealed risk tolerance; and
providing the investment plan to the user.

24. A method for determining replacement income, the method comprising:
accepting user information related to current income and financial reserves and a target date for income replacement;
estimating a value of human capital for a user based on the user information;
determining an insurance plan to cover the estimated value of human capital; and
providing the insurance plan to the user.

25. The method of claim 24, wherein estimating the value of human capital for the user comprises:
estimating future earnings of the user based on the user information; and
calculating a net present value for the estimate future earnings.

26. The method of claim 24, wherein determining an insurance plan to cover the estimated value of human capital comprises:
selecting at least one insurance product determined to replace the calculated net present value of the estimated future earnings.

27. The method of claim 24, further comprising:
prompting a user to provide user information related to the current income and financial reserves.

28. The method of claim 24, further comprising:
receiving a user acceptance of the at least one insurance product.

29. A non-transitory machine-readable medium product, the non-transitory machine-readable medium containing thereon instructions that, when executed, cause a computer to perform a method, the method comprising:
accepting user information related to current income and financial reserves and a target date for income replacement;
estimating a value of human capital for a user based on the user information; and
determining an insurance plan to cover the estimated value of human capital; and
providing the insurance plan to the user.

30. The non-transitory machine-readable medium product of claim 29, wherein the medium comprises one or more of: i) a flash drive, ii) a ROM, iii) a hard disk, iv) a solid state memory device, and v) a CD-ROM.

31. A system, comprising:
a server computer;
a client computer coupled to the server computer; and
a non-transitory machine-readable memory disposed on the server computer and with instructions stored thereon that, when executed by the server computer, perform a method, the method comprising:
accepting user information related to current income and financial reserves and a target date for income replacement into a computer memory;
estimating a value of human capital for a user based on the user information; and
determining an insurance plan to cover the estimated value of human capital; and
providing the insurance plan to the user.
